(19) United States
(12) Patent Application Publication
(10) Pub. No.: US 2016/0006981 A1
(43) Pub. Date: Jan. 7, 2016

(54) METHODS AND SYSTEMS FOR HOSTING INTERACTIVE LIVE STREAM VIDEO EVENTS FOR PAYMENT OR DONATION

(71) Applicant: WIZEO, Boston, MA (US)

(72) Inventors: Guy BAUMAN, Cambridge, MA (US); Avishai STEINER, Jerusalem (IL)

(21) Appl. No.: 14/768,987

(22) PCT Filed: Feb. 19, 2014
(86) PCT No.: PCT/US2014/017232

§ 371 Date: Aug. 19, 2015

Related U.S. Application Data
(60) Provisional application No. 61/766,146, filed on Feb. 19, 2013.

(51) Int. Cl. H04N 7/14; G06Q 30/08

(52) U.S. Cl. CPC H04N 7/147; G06Q 30/08

(57) ABSTRACT

Methods and systems are provided for scheduling and hosting communication events between users and at least one host, such as a sports hero, inspirational person, or celebrity that offers a personal interaction. The platform can process the request, execute a method specified by the host (or by others) in response to the request, determine the user or users that will take place in the communication event, and host the communication event. The communication event may be free or in exchange for payment or a donation, such as to a charity. The communication event may be a one-on-one event, or one or more to many.

### CROSS REFERENCE TO RELATED APPLICATIONS

This application claims the benefit of U.S. Provisional Application No. 61/766,146, filed Feb. 19, 2013, which is hereby incorporated by reference in its entirety.

### FIELD

The present disclosure relates generally to methods and systems for receiving requests for and hosting a communication event between one or more selected users and a host. In particular, the present disclosure provides a platform for people to offer to exchange a monetary amount for the opportunity to participate in the communication event with the host.

### DESCRIPTION OF THE RELATED ART

Auctioning websites, such as eBay, allow people to bid for items they desire. In addition to tangible items such as tickets to concerts and collectibles, people can also bid for an opportunity to interact with a person who inspires them, such as a sports hero, celebrity, visionary, or other famous person. For example, people can bid for a “Power Lunch with Warren Buffet”, where the winning bidder will have the opportunity to dine with Mr. Buffet, and the proceeds from the winning bid will be donated to charity. These opportunities, however, typically have high opening bids, and winning bid is even hither, and beyond the means of the average public. Furthermore, there is typically only one winning bid, and the one winner enjoys the experience upon which he or she bid. As result, other than the designated charity organization and the people the organization serves, only very few people can benefit from Mr. Buffet's largesse, in terms of the time he donated for the event and the wisdom he displayed in the event.

There are also other very successful and famous people who like to use their free time to interact with the general public for charity causes. For example, professional sports organizations like the National. Basketball Association (NBA) host community events, where sports stars participate in community-building activities such as training camps, food drives, etc., and the tickets to such events can be purchased through various web portals. But such events do not happen often, given that sports stars typically have very busy schedules and may find it difficult to find time to take part in a large number of such events. These events may also not be available to individuals that live geographically far away from the host organization. Ultimately, when such a personal interaction is scheduled, many people may be invited and the personal. interaction with any one individual may be limited.

Finally, there are also people who may not be as well-known as celebrities, but who nonetheless have great personal stories to tell, or who simply can inspire anyone through a short chat that lasts for, for example, 10 minutes. There are also people who are eager to be inspired and donate to charities. There are also charity organizations, or other non-profit non-government organizations (NGO), which cannot draw the attention of celebrities but which nevertheless deserve support from the society as they are serving for very noble causes. Therefore, there is a need for a platform to connect together people who want to inspire, people who want to be inspired and/or support charities, and NGOs.

There is also a need for a platform to democratize access to these limited opportunities—such that the opportunity to be truly inspired is not only accessible to a selected few who have the money to spend, but is also accessible to the general public. Therefore, there is a need for a platform to provide inexpensive means of interaction in which everyone can participate by, for example, “crowd-giving” and without spending a fortune.

### SUMMARY

The various embodiments described herein provide a platform that accepts requests to view or participate in a communication event. A scheduling and hosting website allows a user to choose a host with whom the user is interested in communicating and to make a request to participate in a communication event with the host. The website also automatically processes one or more requests from one or more users, executes a method specified by the host or others in response to the requests, selects a user based on pre-determined rules, schedules the communication event, and hosts the communication event at the scheduled time and date. In some embodiments, the method executed involves making a payment. In some embodiments, the website implements a lottery algorithm to select a user, and the amount of payment paid by the selected user may be related to the odds of winning the lottery. In some embodiments, the website implements an auction-style bidding and awards the event to the highest bidders. In some embodiments, the host, alone or together with the selected user, can also invite others to participate (either passively or actively) in the communication event, and/or allow others to access the records thereof, and can set rules and conditions that other people need to satisfy, such as making a donation, in order to be allowed to participate in the event and/or to access the records thereof, and the website will be enforcing and granting permission to these people to participate in the event. The selected user and/or the host may also share the records of the communication event with others for free, or for a fee. The website also allows active participants to control the communication events. In some embodiments, the website may also perform analysis of the content of the events for various purposes, such as blocking improper behavior and identifying portions-of-interest to generate summary clips. In some embodiments, the website is also integrated with other social media sites so that users can share their communication events with others, make requests to other people to become hosts, and to broadcast their activities on the website.

### BRIEF DESCRIPTION OF THE DRAWINGS

FIG. 1 is an illustration of an exemplary system for providing communication event on a communication scheduling and hosting website 110 according to at least one embodiment.

FIG. 2 is an illustration of different components of the communication scheduling and hosting website 110 according to at least one embodiment.

FIG. 3 is a flowchart illustrating an exemplary method for providing a communications event to a selected user in a manner consistent with the present disclosure.

FIG. 4 illustrates an exemplary embodiment in which users can browse for the information of the hosts and search for additional hosts.

FIG. 5 illustrates an exemplary embodiment where additional information about the hosts is displayed.

FIG. 6 illustrates an exemplary embodiment where additional information about the hosts is displayed and a request can be accepted.

FIG. 7 illustrates an exemplary embodiment of popup notification showing that a request has been processed, as well as the date and time when a determination of the winner will occur.

FIG. 8 illustrates another exemplary embodiment in which users can browse for the information of the hosts, submit a request for a communication event with the hosts, request for new hosts, and propose new NGOs to receive contribution from users who submit the requests.

FIG. 9 illustrates another exemplary embodiment where additional information about the hosts is displayed and a request can be accepted.

FIG. 10 illustrates an exemplary embodiment where options for amount donation are displayed and an amount can be entered.

FIG. 11 illustrates an exemplary embodiment where payment information can be entered.

FIG. 12 illustrates an exemplary embodiment of a video-chat interface.

FIG. 13 illustrates an exemplary embodiment where information about the fund raised by a host for an NGO is displayed.

The figures depict exemplary embodiments for purposes of illustration only. One skilled in the art will readily recognize from the following discussion that alternative embodiments of the structures and methods illustrated herein may be employed without departing from the principles of the inventions described herein.

### DETAILED DESCRIPTION OF EXEMPLARY EMBODIMENTS

Embodiments described herein provide a democratized platform for providing content to the public that integrates the process of accepting requests for a communication event with the hosting of the event. Such platform allows a user to select a host with whom the user is interested in communicating, and request to participate in the communication event. As used herein, a “host” may be a person or entity that is offering desired content. A person, such as a sports hero, inspirational person, or celebrity that offers a personal interaction, may also be referred to as a “wiz”. The platform can process the request, execute a method specified by the host (or by others) in response to the request, determine the user or users that will take place in the communication event, and host the communication event.

In some embodiments, there may be only one user, which may be referred to as “the user” or the “selected user.” In other embodiments, there may be a selection process for determining which one or several of many will be the receiving user(s). In these cases, the user may be referred to as the “selected user(s)”. In some embodiments, the selection process may be a game-type selection process where the receiving user(s) may be referred to as “winner(s)”

In some embodiments, the platform can implement a lottery system where every requester will have a certain probability to win the event, rather than a traditional auctioning system where the highest bidder always wins. The winner can also invite others to participate (either passively or actively) the communication event, and/or allow others to access the records thereof. The winner (or the host) can set rules and conditions that other people need to satisfy, such as making a donation, in order to be allowed to participate in the event and/or to access the records thereof, and the website will be enforcing and granting permission to these people participate in the event. The winner, the host and/or the operator of the website can also share the records of the communication event with others for free or for a fee. If the communication event is a video-chat session, the platform can also perform analysis on the video and/or audio data to look for specific patterns, so as to block improper conduct or utterances by any of participants, and/or to retrieve portions-of-interest to generate summary clips for sharing.

Some portions of the discussion herein may relate to users placing a “bid” or a “donation” (or payment), in order to take part in a lottery or raffle or random selection of a “winner” (or of several winners), such that the winner(s) may conduct one or more communication events with one or more hosts. However, in some embodiments, users may not be required to “bid” or to pay money, or to compete in an auction-type bidding process. In some embodiments, the term “bid” as used herein may be regarded as merely “participating”, or casting a virtual vote or a virtual request which may not necessarily be accompanied by actual payment of money. In some embodiments, the winner(s) may participate in a communication event in which the host communicates with multiple participants, including people who did not bid or who are not the winner(s). In some embodiments, the winner(s) may participate in a communication event which only involves the host and the winner(s). Accordingly, the term “bid” may be used herein to include also participation by a user who sends a request for the communication event, and which may or may not be accompanied by actual payment of money.

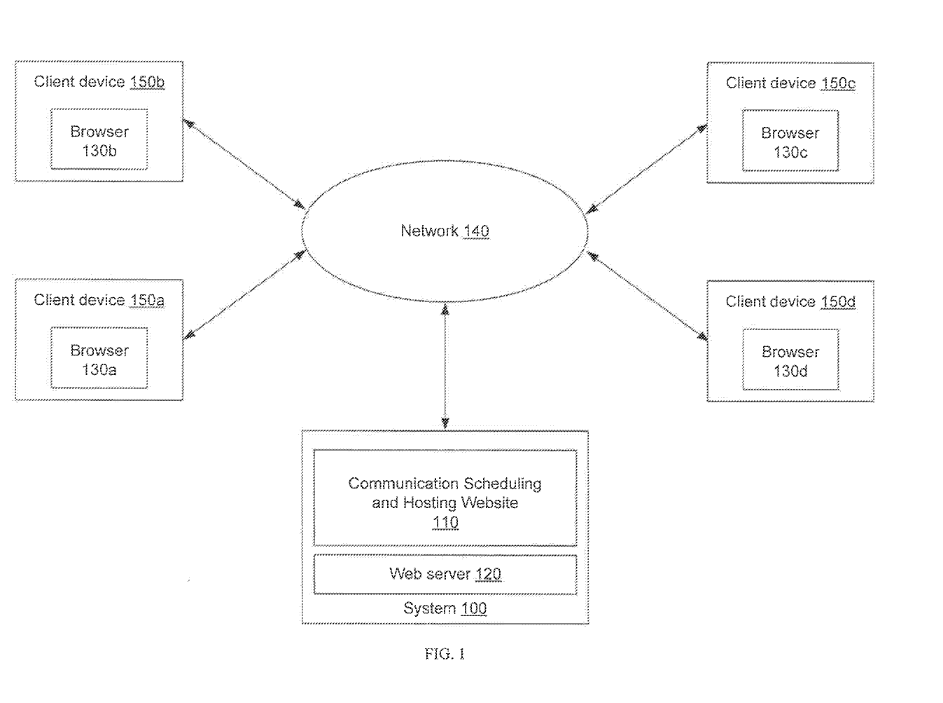

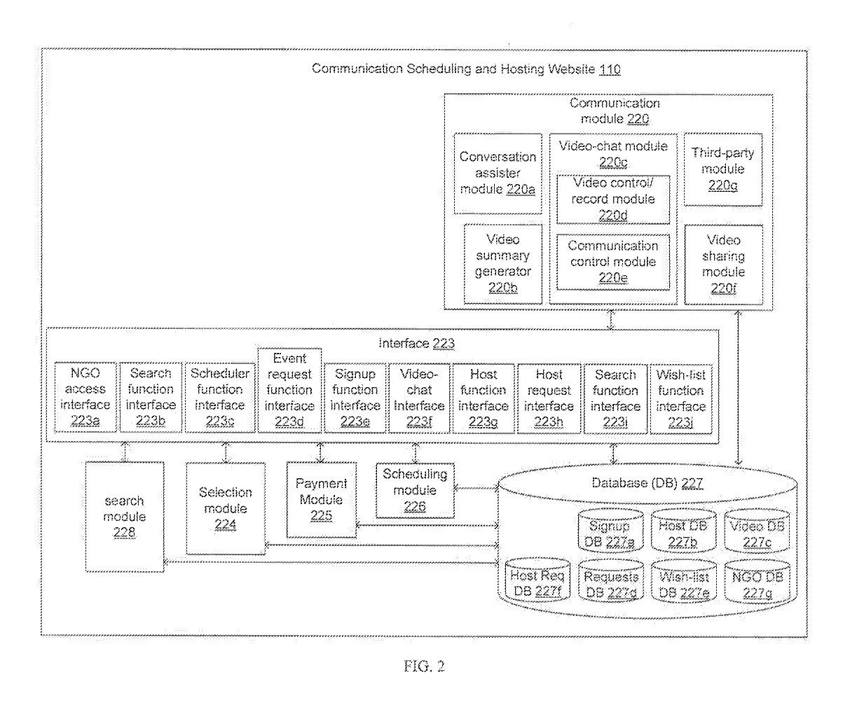

FIG. 1 illustrates a communication scheduling and hosting website 110. Website 110 has multiple modules (to be disclosed with respect to FIG. 2) that operate on a web server 120. The web server 120 is implemented as a server program executing on a system 100. Web server 120 facilitates communication between website 110 and client 150. For example, the server can receive a first stream of data from client device 150 ((e.g. client 150a) and provide the data to some of the modules of website 100. The modules of website 100 can process the first stream of data and then provide a second stream of data to web server 120. The server can then transmit the second stream of data to another client device 150 (e.g. client 150b).

System 100, on which web server 120 runs, can be any computer system adapted to serve content using any internetworking protocols and is not limited to Internet or the HTTP protocol. System 100 typically comprises one or more CPUs, memory, wired and wireless network interfaces, storage units, input and output units, and other suitable hardware components. In some embodiments, System 100 also runs an operating system such as LINUX, Microsoft Windows, Mac OS, etc. In general, functions described in some embodiments as being performed on the server side can also be performed on the client side in other embodiments if appropriate. The functionality implemented by any of the aforementioned software and hardware components can also be provided from computer program products that are stored on computer-readable storage media, which may include but is not limited to RAM, hard disk, and optical/magnetic media.

In at least one embodiment, client device 150 executes a browser 130 and can connect to the web server 120 to access the content of website 110 over a network 140. Client device 150 may include a variety of different computing devices with CPUs, memory, wired and wireless network interfaces, storage units, input and output units, and other suitable hardware components. Some examples of client devices 150 include personal computers, notebook computers, smart phones, tablets, and other mobile devices, etc. Network 140 is typically the Internet, but can also be any network, including, but not limited to any combination of a LAN, a MAN, a WAN, a mobile, wired or wires network, a private network, or a virtual private network. While only four clients 150a, 150b, 150c, and 150d and their respective browsers 130a, 130b, 130c, and 130d are shown, it is understood that very large numbers of clients may be supported and can be in communication with website 110 at any time.

Client devices 150 can also cause browsers 130 to transmit data through network 140 to web server 120, which then transmits the data to other client devices. Likewise, client devices 150 can also cause browsers 130 to receive data through network 140 from web server 120, which then receives the data from other client devices 150. Browsers 130 also allow user to access various contents of website 110 and to provide data, including video and/or audio data, to web server 120 through various interfaces (to be disclosed in FIG. 2). In at least one embodiment, website 110 can host a video-chat session by using technologies such as WebRTC, such that browsers 130 can collect video and audio data using the input units of client devices 150 and transmit the data to web server 120, while also receiving data from web server 120. In other embodiments, a dedicated application (e.g. Adobe Flash plug-in, or software similar to Microsoft Skype and/or Messenger) can also be installed on client device to perform substantially the same function. Some examples of browsers 130 are Microsoft Internet Explorer, Netscape Navigator, Mozilla Firefox, and Apple Safari.

FIG. 2 illustrates the various exemplary components of website 110. In some embodiments, the components of website 110 are implemented in computer languages such as HTML5, JavaScript, and PHP. Some of the components shown in FIG. 2 can be omitted in other embodiments. Each module implements one or more certain functions and may interact with the user through interface 223, and may interact with client devices 150 through, for example, web server 120 (not shown in FIG. 2). “Interface” refers to a graphical user interface, or elements thereof, displayed and/or broadcasted on client devices 150. Such interface may include one or more elements such as a textbox, a text panel, a button, an icon, a video panel, sound track, or any other elements which the user can use for input and output purpose. The interface elements may be displayed and/or broadcasted in browsers 130, but is not required. Also, at any given time there can be multiple instances of the same interface instantiated in different devices, such that different users may interact through different embodiments of the same interface. In addition, there is also a database 227 which has various sub-databases storing information including but not limited to the profiles of the users and the hosts, as well as communication event records (e.g. video and/or audio files), which the modules can access. In some embodiments, database 227 is implemented with MySQL.

Host function interface 223g allows any person, who may also be a user of website 110, to apply to be a host or, once registered as a host, to maintain his or her information. In some embodiments, host function interface 223g also allows other people, who may or may not plan to register as a host or a user, to submit information about a NGO they wish to support. The host applicant may be prompted by interface 223g to provide a list of information about the host, including but not limited to his/her name, picture, profession, category, biography, preferred discussion topics, and schedule when the host is available. The information may also include a description of what a requester must do in order to obtain the participation of the host, such as for example, make a payment to the host or third party, or make a donation to a designated charity or NCO. A scheduling module 226 allows the host to indicate the times and dates when the host will be available for a communication event, and then may display the information to users who wish to make a request to participate in the communication event. In sonic embodiments, the information includes a link to an NGO database 227g which contains various information about the NGOs, including the NGOs' names, missions, images, website addresses, etc. In some embodiments, the information may further include such information as required amount, a time frame for making the request, and the number of requests the person (after he or she has become a host) has received. In some embodiments, direct by to the NGOs (instead of NGO database 227g) are included in the method information. The information provided by the host applicant can then be stored, for example, as part of the host's profile, in a host database 227b. At least part of the information stored in the host profile will be displayed in the website's homepage. In some embodiments, a “live” timer based on the time frame of submitting a request for a communication event with a host can be displayed in the homepage as well.

Signup function interface 223e allows any user to register with website 110, and after registration, to log into website 110. The user applicant may have to provide a list of information, including but not limited to his/her name, E-mail address, password, etc. After registration, a returning user will be able to log into website 110. In some embodiments, the user can log into website 110 through a social media website, such as Facebook. After logging in, the user will be able to submit a request for a communication event with a host through an event request function interface 223d. At least some of the information provided by the user can be stored as part of the user's profile in a signup database 227a. In some embodiments, the user can add a host to his or her wish list through a wish-list function interface 223j. In some embodiments, the user can search for a host through a search function interface 223b. In some embodiments, the user can also request another person to register as host through a host request interface 223h.

Event request function interface 223d allows a user to make a request for a communication event with a host. In at least one embodiment, interface 223d provides a “meet” button which, when clicked on by the user, brings the user to an event request page which displays the method information entered by the host, which may include a link to the NGO database 227g, the required action (e.g. required amount of payment or donation), the time frame of making a request, etc. In some embodiments, a user may be allowed to post a question to the host, regardless of whether the user participates in the request process, and the question can be displayed to other users in the event request function interface 223d. In some embodiments, the event request page may further contain a “Contribute” button which, when clicked on by the user, brings the user to a payment page, which interacts with a payment module 225. In some embodiments, the payment module 225 allows the user to donate to one or more NGOs designated by the host, by providing payment information, such as payment card details (e.g. credit card) or information for other payment methods (e.g. PayPal, or tokens issued by the operator of website 110 or by other entities). In some embodiments, the user may be allowed to gift his or her request (processed by the website after making a donation or carrying out an activity) to another user. In some embodiments, the user may be allowed to donate an amount which may or may not be the same as the required amount of payment specified by the host. For example, the user may be allowed to donate more or less than the specified amount.

In some embodiments, payment module 225 also allows the host to donate to the NGOs. In some embodiments, payment module 225 may also have an outgoing payment module which allows the system to accumulate all the donations paid by users in association with a particular communication event with a host, and/or to keep a pre-defined commission for handling and processing fees, and/or to forward the remainder to the one or more NGOs designated by the host. In some embodiments, the payment made by the user can also be stored and updated as part of the user's profile. In some embodiments, the user can make the request as a gift to another user, and the beneficiary user's profile can be updated in signup database 227a as well.

In some embodiments, the requests put in by the user can update information stored in the host database 227b, including the number of requests the host has received. In some embodiments, the requests put in by the user can also be stored in a requests database 227d which can then be linked to other databases including but not limited to signup database 227a, host database 227b, and NGO database 227g. In some embodiments, website 110 can broadcast some information about the requests made by the user (e.g. amount donated or participated activities) via various mediums, such as social media sites. In some embodiments, interface 223 also includes an NGO access interface 223a which allows the non-profit organization concerned to view the amount of funds raised, or other relevant financial information. In some embodiments, NGO access interface 223a includes a “dashboard” style element which shows graphically the percentage of a targeted amount of funds raised for the NGO. In some embodiments, NGO access interface 223a also displays the fund raised by a particular host for the NGO.

Wish-list function interface 223j allows a user to put a host, or any upcoming communication event associated with the host, in his or her wish list, instead of requesting the event right away. In some embodiments, interface 223j provides a wish-list icon when the host profile is displayed. In some embodiments, the icon can also be displayed in the event request page which the user accesses from the event request function interface 223d. When the user clicks on the icon, a host wish-list data structure can be updated. In some embodiments, the host wish-list data structure can be stored as part of the user's profile in signup database 227a. In some embodiments, the wish-list data structure can also be stored in a wish-list database 227e which can then be linked to other databases including but not limited to signup database 227a. In some embodiments, the display of the profile of a host whom the user has placed on a wish list may change. In some embodiments, the user can access his or her wish list through a hyperlink as the user logs into website 110.

Search function interface 223b allows a user to search for a host. In some embodiments, interface 223b prompts a user to enter some information, which includes at least a name, of a person whom the user wishes to communicate with through website 110. A search module 228 can then perform a first search of the information over the Internet. In some embodiments, module 228 may also use a third party search engine to perform the search. Interface 223b can then display a first search result and to receive confirmation from the user about whether the desired host information is listed in the first search result. Upon receiving confirmation from the user, module 228 may then perform a second search in the host database 227b to locate the host profile, and to allow the user to place a host on a wish list or make a request for a communication event with the host henceforth. In some embodiments, interface 223b can bring the user to a host request interface 223h if the host cannot be located in the database 227b.

Host request interface 223h allows the user to make a request to another person to become a host. In at least one embodiment, interface 223h displays the first search result by search module 228 and allows the user to either update an existing request to a person listed in the first search result, or to create a new request. In some embodiments, to create the new request, interface 223h may prompt the user to enter additional information about the person whom the user wishes to send the new request. The information may include a URL (united resource locator) of a homepage of the person, or of the person's page on social media sites. In some embodiments, search module 228 may use the additional information to perform a third search to find out whether there is an existing request for the person, or whether the person has already registered as a host. In some embodiments, website 110 uses a host request database 227g to store the request information, which may include the name of the person requested, the URL of the person's homepage (or of the person's page on social media sites), users who made the request, etc. The database can be linked to other databases including but not limited to signup database 227a. In some embodiments, users can log into website 110 through social media sites such as Facebook, and join an existing request by using tools specifically provided by the media site, such as “LIKE” or “SHARE” via Facebook.

After processing all the requests from the users, selection module 224 selects one or more users or determines the winner(s). In some embodiments, module 224 awards the event to the highest bidders (e.g. the person who paid the most). In some embodiments, module 224 utilizes a raffle or lottery to randomly (or pseudo-randomly) select one or more winners. In some embodiments, the probability of winning is directly related to the amount of payment. In some embodiments, the probability of winning is not affected by the amount of payment. In some embodiments, payment may be entirely optional and the user may not be required to contribute any monetary amount at all. In some embodiments, the pre-defined rules are set up, like a contest, to determine one or more winners, and the winners will be selected by the module according to the rules. After the one or more winners receives a notification, such as an email, from website 110, the winners can schedule the event through a scheduler function interface 223c, which invokes scheduling module 226 to store the event schedule information.

At the time and date of the scheduled communication event, website 110 will host the event. In some embodiments, such event is a video-chat session, in which participants can use client devices 150 and browsers 130 to send and receive communications, which may include video, audio, text, or other data, through a video-chat interface 223f, which then interacts with communication module 220. Communication module 220 may include a video-chat module 220c that handles video and/or audio data. In some embodiments, video-chat module 220c also handles text messages. The communication data can come from various sources—such as from a camera, smartphone, or microphone, or some or all of which may be pre-recorded. In some embodiments, video-chat interface 223f allows different pre-recorded sound effects, such as applause and laughing, to be added in the audio stream of the video-chat session. In some embodiments, at least part of the elements of video-chat interface 223f (e.g. background graphic, sound track, etc.) can be configured for a particular video-chat session. In some embodiments, video-chat interface 223f includes a link to payment module 225 which allows the participants to donate during the video-chat session.

In some embodiments, video-chat module 220c supports one-on-one interactive video-chat. In some embodiments, video-chat module 220c supports one-to-many interactive video-chat. Video-chat module 220c may further include a video control/record module 220d, which allows the user, through the video-chat interface 223f, to perform various processing steps of the video, which include but not limited to recording, capturing still shots, setting back drop, etc., and the data can be stored in a video database 227c. In some embodiments, module 220d can also automatically add data to the video stream, such as putting the name of the host, the user, the logo of the non-profit organization, or other information, to be displayed in the video-chat session.

In some embodiments, video-chat module 220c also includes a communication control module 220e which allows one or more participants to control the flow of the session. In some embodiments, uneven powers of control are given to the session leader (either the host or other designated session leader(s)) and the users to create an asymmetric video-chat session. For example, the session leader may be able to mute the microphone of the users but not vice versa. In some embodiments, control module 220e allows the session leader to unilaterally prolong the session. In some embodiments, control module 220e allows the session leader to unilaterally end the session. In some embodiments, control module 220e can be configured to block the video and/or audio data stream from the users if, for example, the users engage in improper conducts, by performing analysis on the video and/or audio data to automatically identify a specific pattern, such as body-parts, gesture, etc., and/or upon receiving information from other participants. In some embodiments, the video and/or audio data stream is buffered to create a buffer delay, to allow more time for making the determination to block the data. In some embodiments, communication module 220 also include a conversation assister module 220a which can provide information relevant to the substance of the video-chat session to each participant, such as suggested questions, answers, phrases and topics, with the information determined separately for each participant and based in part on the profile of each participant, while the session is underway, in order to assist the participants in conducting a high-quality conversation.

In some embodiments, communication module 220 include a third-party module 220g which allows third-party users (e.g. users who are not the selected users or winners for the event) to participate, either actively or passively (e.g. just watching or listening to), the video-chat session, or to access the record of the session after it ends, upon approval by the original participants and/or by the session leader. In some embodiments, the original participants may set some conditions, such as making certain amount of donation or performing an action on a social media site, which website 110 verifies, and then module 220g may automatically allow the third-party users to participate the video-chat session and/or to access the record of the session. In some embodiments, during the video-chat session interface 223f may accept data (e.g. text message) from the third-party viewers, which is then processed by video-chat module 220c and transmitted to other participants. In some embodiments, interface 223f may accept the data from the third-party viewers after some conditions are met (e.g. approval by other participants). In some embodiments, after interface 223f receives the data from third party, video-chat module 220c transmits the data to the session leader, and the data will then be automatically added to the video and/or audio data stream through video control/record module 220d. In some embodiments, after one instance of video-chat interface 223f, instantiated at the device of a third party viewer, receives the data (e.g. text message) from the third party viewer and transmits the data to hosting website 110, video-chat module 220c of website 110 transmits not only the data from the third party viewer but also other relevant information (e.g. approval of the third party viewer's data) received from other participants to the session leader and displays the aforementioned data and information in another instance of video-chat interface 223f instantiated at the device of the leader, and allows the leader to decide to include the data in the video-chat session by, for example, adding the data into the video and/or audio data stream through video control/record module 220d. In some embodiments, interface 223f provides a “drag-and-drop” feature which allows the session leader to select data (e.g. text instant message) from the third-party viewer graphically through one element (e.g. a text panel) of video-chat interface 223f, and to include the data into the video and/or audio data stream by “dragging” the data and “dropping” it into another element (e.g. a video panel) of interface 223f. In some embodiments, the text message can be displayed in a separate panel of the video-chat interface 223g. In some embodiments, when the session leader selects to include data from a third-party viewer into the communication data stream, the third-party viewer automatically becomes an active participant to the video-chat session and can communicate with the host (or other participants) through video-chat module 220c.

In some embodiments, communication module 220 may include a video sharing module 220f which allows the participants to a video-chat session hosted by website 110 to share the recordings with others by, for example, email or through social media sharing applications and/or services. In some embodiments, communication module 220 includes a video summary generator 220b which can automatically produce a summary clip of the video-chat by automatically identifying portions of interest (e.g. by identifying a specific pattern such as gestures), and selectively including such portions, which may be accompanied with the appropriate audio tracks, in the summary clip. In some embodiments, communication module 220 also includes a transcript generator module (not shown in FIG. 2) to automatically generate a textual transcript of the video-chat by using speech recognition technologies.

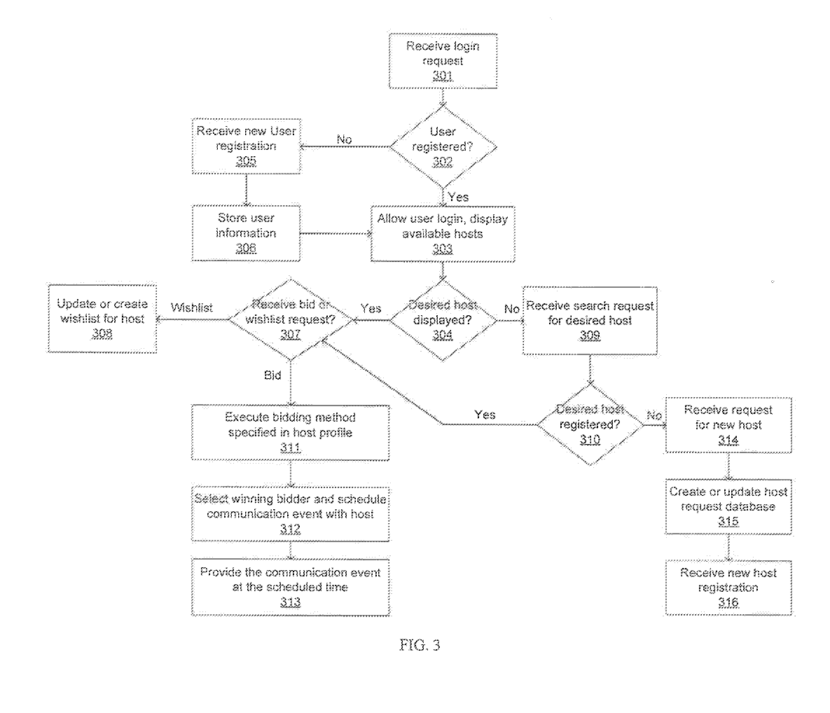

FIG. 3 is a flowchart illustrating an exemplary method, executed by website 110 of FIG. 1 and 2, to allow a user to search for a host and to make a request for a communication event with the host, or to make a request to a person to become a host, according to at least one embodiment. Some of the steps shown in FIG. 3 can be omitted in other embodiments of this invention. Initially, website 110 receives a login request from user in step 301. The website authenticates the user in step 302 by accessing signup database 227a. If the user is not registered, step 305 will be executed, which brings up signup function interface 223e to allow the first-time user to put in his or her information, and then step 306 will be executed by storing the new user information in a profile in signup database 227a, and allow the user to remain login by executing step 303. If the user is registered, website 110 will execute step 303 right away after receiving the user's login credentials. In step 303, website 110 also the hosts' information. In some embodiments, step 303 can allow the user to categorize the hosts by accessing the category information in their profiles stored in host database 227b. In some embodiments, the user can use the category information to filter and to retain a list of hosts for display. In some embodiments, step 303 can also provide an infinite scroll down feature to keep displaying more hosts as the user scrolls down the screen. If the user cannot find the desired host, website 110 will execute step 309 to receive a search request for the desired host, through search function interface 223b. After performing the search, the search function interface 223b will display the search result. If the search result indicates that the desired host has not registered, website 110 proceed to step 314 to receive request for new host from the user, through host request interface 223g. After receiving the request, website 110 will proceed to step 315 where, depending upon whether there is an existing request, a new request can be added to host request database 227f, or an existing request in the database 227f can be modified. The prospective host can then register with website 110 as a host.

Going back to step 304 and step 310, if the desired host can be located in either step, website 110 will then execute step 307, where the system will either receive a request for a communication event with the host, or a wish-list request from the user. If the user merely wants to place the host on a wish list, step 308 will be executed, where the user will create or update his or her wish list through wish-list function interface 223i. In some embodiments, a wish-list data structure in the user's profile will be created or updated. In some embodiments, a wish-list database 227e will be created or updated. If the user wants to submit a request for a communication event with the host, step 311 will be executed, where the event request function interface accepts the request and may invoke payment module 225 to perform the method specified in the host's profile. In some embodiments, databases such as signup database 227a and NGO database 227g may also be updated to reflect the request activity. After the time for accepting requests ends, step 312 will be executed, where selection module 224 will select the one or more winners, and scheduling module 226 will schedule the event according to the schedule information in the host's profile. Finally, at the time and date of the scheduled event, website 110 will provide the communication event via, for example, video-chat interface 223f if the communication event is a video-chat session.

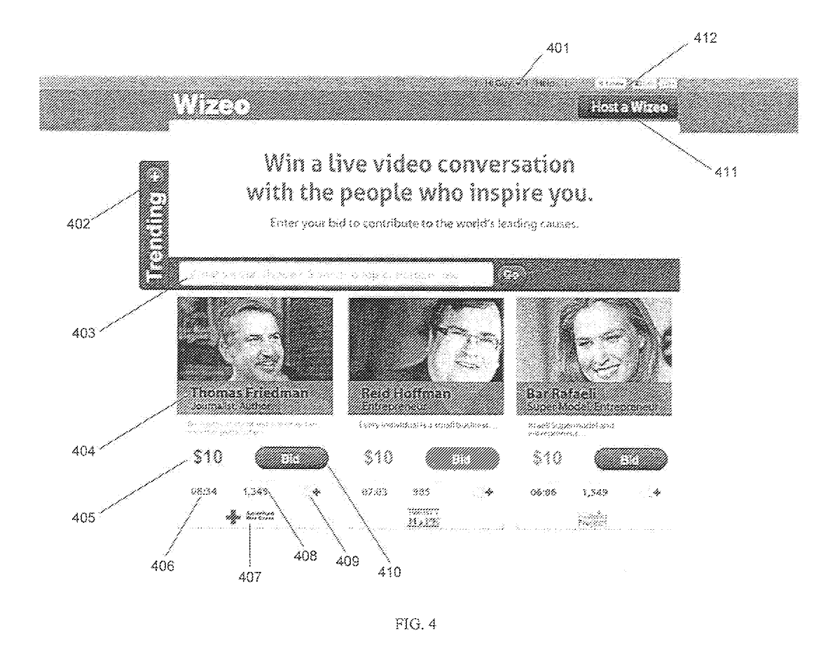

FIG. 4 illustrates exemplary interface elements that may be available to the user when he or she logs into website 110. Information of various hosts is displayed, which includes elements 404 (the name), 405 (the amount of payment), 406 (time remaining for making a request), 407 (a NGO designated by the host to receive the proceeds), and 408 (number of requests received). Icon 410, upon being clicked on, activates an action (such as making a payment) specified by the host, which then triggers a method (such as making a monetary transfer) to be executed by website 110 to process the request. Icon 409, upon being clicked on, allows the user to add the host to his or her wish list. Icon 402 allows user to categorize the hosts displayed, by accessing the host's category information stored in host database 227b. In at least one embodiment, the user can use the category information to filter and to retain a list of hosts for display. Textbox 403 allows the user to input a query for a host, for a topic, or for other inquiries. Heart-shaped icon 401, which can be part of wish-list function interface 223i, allows a user to expand the interface by adding icon 409 to the host profile displayed, so that user can add the host to his or her wish list. Icon 411 allows a user to apply to become a host. The user can also access other media sites through the interface to, for example, perform a specific action required by the host, other than making a payment.

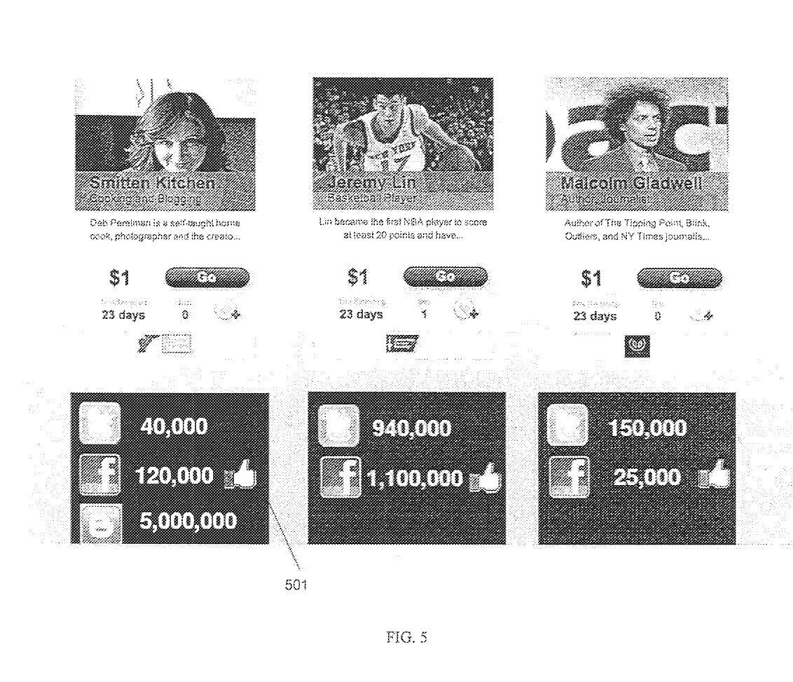

FIG. 5 illustrates other exemplary interface elements for displaying the host profiles. Element 501 display information from the host's pages on various social media sites, such as Facebook and Twitter. In this embodiment, the information includes the number of “LIKES” the host received for his or her Facebook page, and the number of followers to his or her Twitter account.

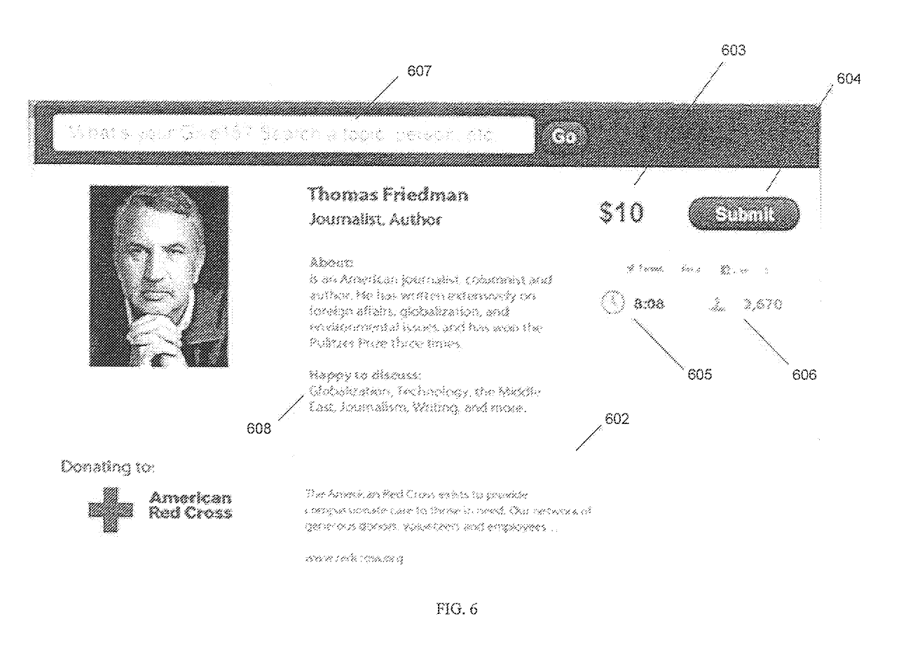

FIG. 6 illustrates other exemplary interface elements displayed when the user selects a host by clicking on icon 410 in the embodiment of website 110 as shown in FIG. 4. The information displayed include 603 (the amount of payment to make a request), 605 (time remaining for making the request), and 606 (number of requests received). Additional information element 608 about the host is displayed, such as “Happy to discuss”, which is not shown in FIG. 4. Additional information element 602 about NGO, including mission statement and a hyperlink to the NGO site, is also displayed. Icon 604 is also displayed which, upon being clicked on, activates the action (such as making a payment) which then triggers a method (such as monetary transfer) to be executed by website 110. Textbox 607 allows the user to input a query for a host, for a topic, or for other inquiries, and can bring the user out of this host profile to another page.

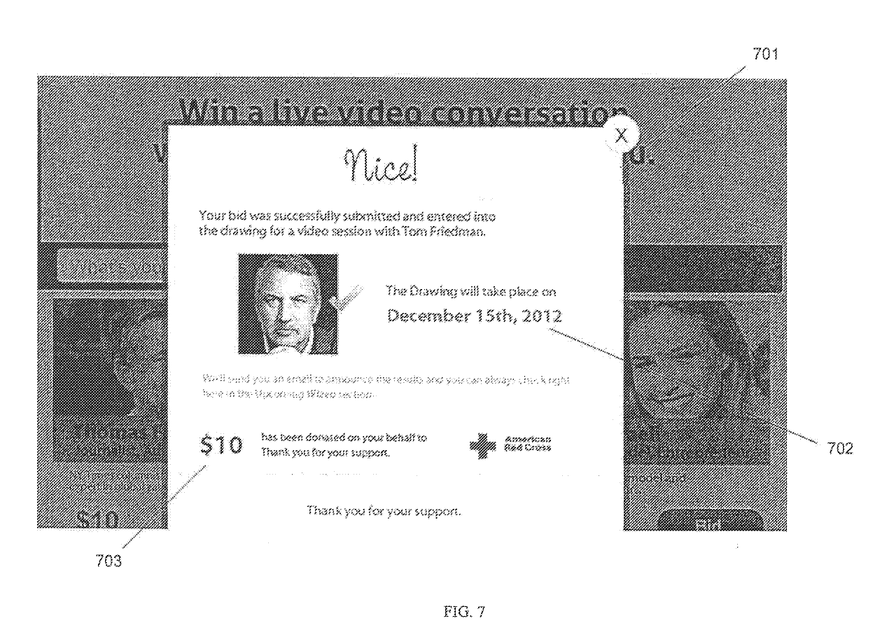

FIG. 7 illustrates an example embodiment of a popup notification 701, which includes element 703 showing a request has been processed in response to, for example, a payment being made, and element 702 showing the date at which the winner(s) will be determined.

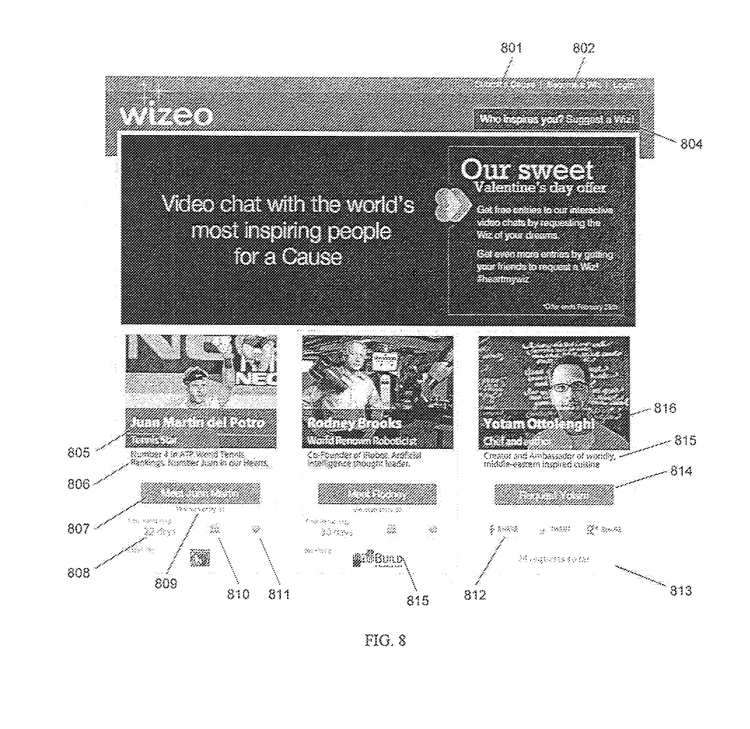

FIG. 8 illustrates other exemplary interface elements that may be available to the user when he or she logs into website 110. Information of various hosts is displayed, which includes elements 805 (the name), 806 (a short biography), 809 (minimum amount of payment required to make a request for a communication event), 808 (time remaining for making the request), and 815 (a NGO designated by the host to receive the proceeds). Icon 807, upon being clicked on, allows the user to activate an action (e.g. making a payment) specified by the host, which then triggers the method (e.g. making a monetary transfers designated by the host. Icon 810, upon being clicked on, allows the user to gift a request (processed after the method is executed) to another user. Icon 811, upon being clicked on, allows the user to add the host to his or her wish list. In addition, information of potential hosts is also displayed, which includes elements 816 (the name), 817 (a short biography), and 813 (number of requests for host received). Icon 814, upon being clicked on, allows the user to make a request to the person to become host, and host request database 227f can be updated accordingly. Icons 812 represent links to popular social media websites such as Facebook, Twitter, Google+, where the user can join an existing request for that person to become a host. In addition, element 801 allows the user to “submit a cause” which, in this particular embodiment, allows the user to submit a NGO to the website. Upon approval, the NGO will be eligible to be designated by a host to receive contribution by the user as he or she made the request for a communication event. Besides, element 802 leads a person to host function interface 223g to apply to be a host, while element 804 allows a person to “suggest a wiz”, which starts the process of searching for a host and update or create a request for a host, as shown in FIG. 3.

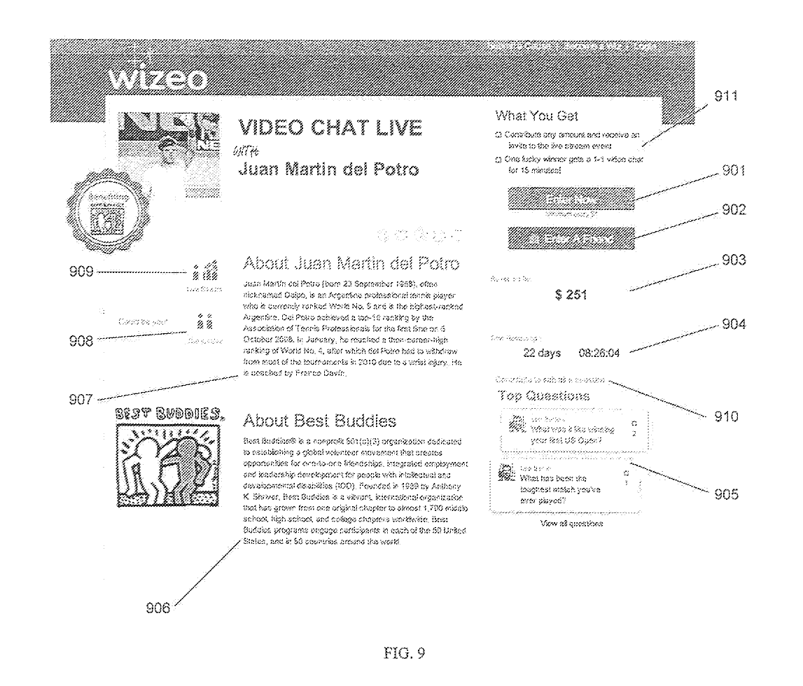

FIG. 9 illustrates other exemplary interface elements displayed when the user selects a host by clicking on icon 807 in the embodiment of website 110 as shown in FIG. 8. The information displayed include elements 909 (an option to have one-to-multi-party live stream session with the host), 908 (an option to have a one-to-one session with the host), 907 (detailed information about the host), 906 (detailed information about the NGO, such as fundraising goal), 905 (questions posted by other users to the host), 904 (time remaining for making the request), 903 (amount of donation raised), and 911 (required action, such as making a donation, specified by host, and additional information such as what to expect after making an donation). In addition, icon 901, upon being clicked on, leads the user to an interface where an amount of contribution can be entered, while icon 902, upon being clicked on, allows the user to gift the request (with contribution fulfilled) to another user. Element 911 allows the user to post a question, which can be displayed later in information element 905.

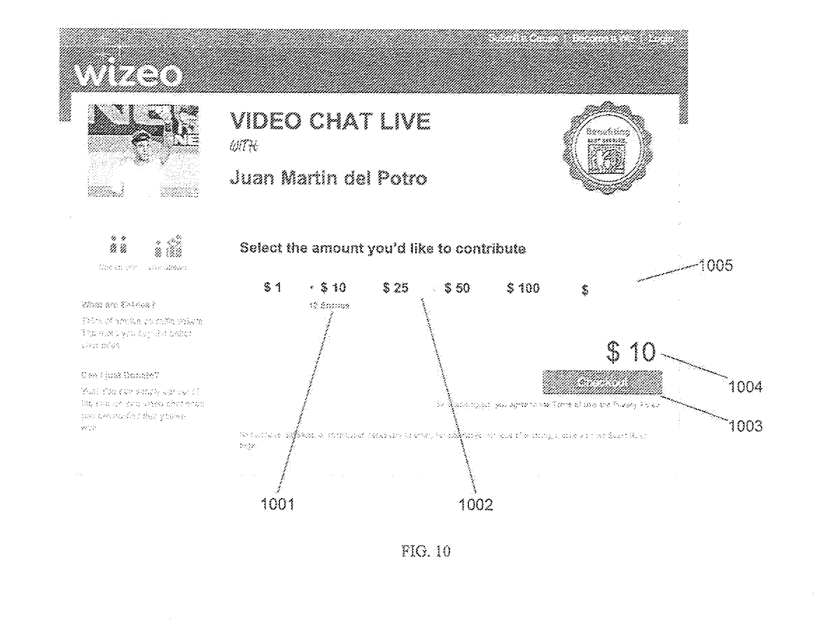

FIG. 10 illustrates an exemplary interface where the user can select the amount of donation, upon clicking on icon 901 in FIG. 9. Element 1002 shows the payment options, while text field 1005 allows the user to put in any amount. Element 1001 also shows the number of “entries” a particular amount of donation can buy, wherein the number of entries correlate with the odds of winning the event (in this embodiment bidding is in the form of a raffle). Element 1004 shows the amount entered by the user, while icon 1003, upon clicked on, can lead the user to a payment page where payment information can be entered to complete the request for the communication event.

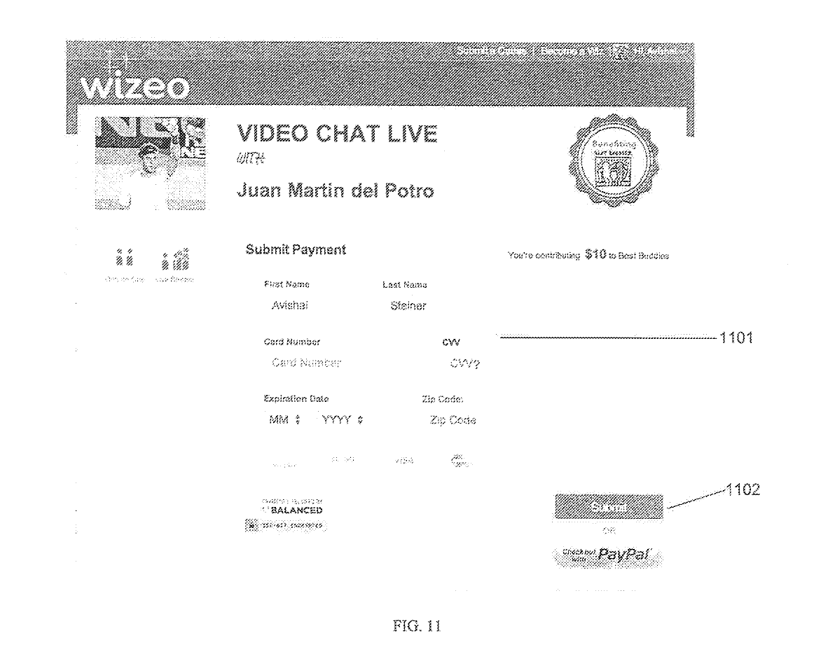

FIG. 11 illustrates an exemplary interface where the user can input information needed to complete the donation (and hence the request for the communication event). Text fields 1101 allow the user to put in financial information, such as credit card number, for the monetary transfer to take place. Alternatively, other modes of monetary transfer, such as paypal, can be used. Upon submitting the financial information, which can be triggered by clicking on icon 1102, website 110 may automatically execute a monetary transfer to the designated NGO and the donation can be completed.

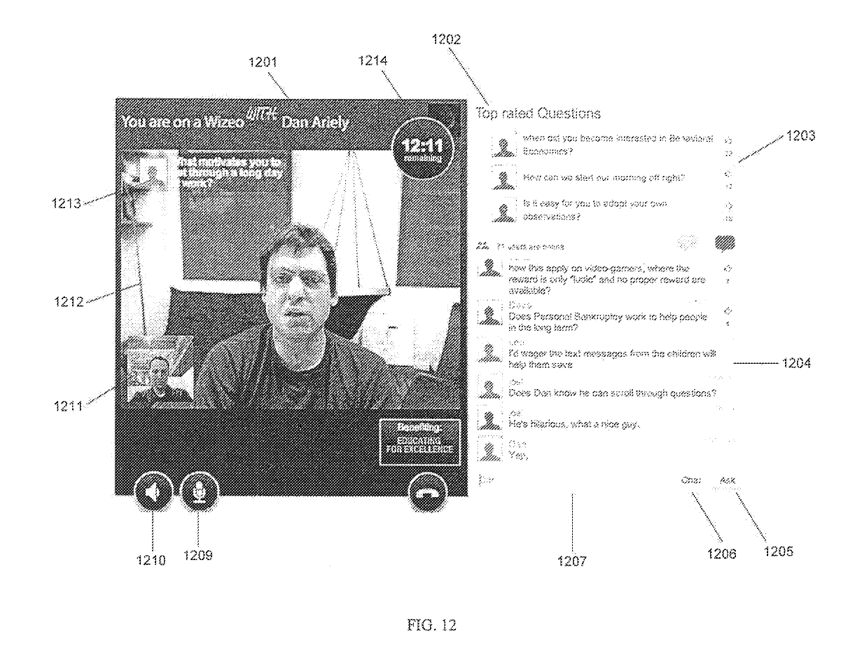

FIG. 12 illustrates an exemplary video-chat interface displayed to a user, which includes a video interface 1212 showing live video of the other party (e.g. the host), a video interface 1211 showing live video of the user, element 1201 showing the name of the host, and element 1214 showing the time remaining for the video-chat session. In addition, icon 1210 allows the user to control the volume, while icon 1209 can control the microphone of the user. In some embodiments, both the user and the session leader (e.g. the host) can control the microphone. If the user is not eligible to speak (e.g. banned by the session leader, or joining the session passively as a third-party viewer), icon 1209 can be shown in a disabled state. On the right of video interface 1212 there are text panels. The user can key in some text in text field 1207 and can designate it to be a chat, by clicking on icon 1206, and the text can be displayed to everyone participating in the Video-chat session. Alternatively, the user can designate the text to be a question, by clicking on icon 1207, and the question can be transmitted to the session leader and other participants through video-chat module 220c. The questions can be displayed in panel 1204. As shown in FIG. 12, participants can vote or approve on the questions (in, for example, social media websites such as Facebook), and the voting result can be displayed to the session leader as well. Questions can be ranked based on approval by participants, and can be included in the video stream in a text box 1213.

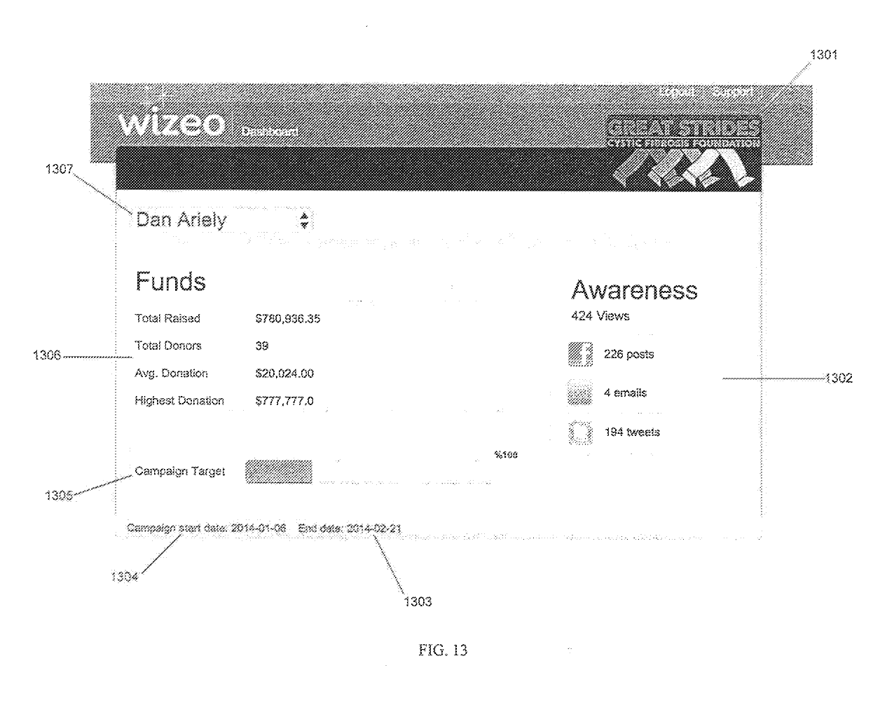

FIG. 13 illustrates an exemplary interface where information about the fund raised by a host for an NGO is displayed, which include element 1306 (fund raised, number of donors, etc.), element 1304 (the beginning date when donation is accepted), element 1303 (the end date for donation), and element 1302 (other information such as how well the NGO is followed in social media sites). In addition, a dashboard element 1305 is displayed which shows graphically the percentage of targeted amount of donation has been raised. The information displayed can also be customized for each host who designated the NGO for bidding, through a selection element 1307.

Some portions of the above description present features of the inventions described herein in terms of algorithms and symbolic representations of operations on information. These algorithmic descriptions and representations are the means used by those skilled in the art to most effectively convey the substance of their work to others skilled in the art. These operations, while described functionally or logically, are understood to be implemented by computer programs. Furthermore, it has also proven convenient at times, to refer to these arrangements of operations as modules or code devices, without loss of generality.

It should be borne in mind, however, that all of these and similar terms are to be associated with the appropriate physical quantities and are merely convenient labels applied to these quantities. Unless specifically stated otherwise as apparent from the present discussion, it is appreciated that throughout the description, discussions utilizing terms such as “selecting” or “computing” or “determining” or the like, refer to the action and processes of a computer system, or similar electronic computing device, that manipulates and transforms data represented as physical (electronic) quantities within the computer system memories or registers or other such information storage, transmission or display devices.

Certain aspects of the inventions described herein include process steps and instructions described herein in the form of an algorithm. It should be noted that the process steps and instructions of the present invention can be embodied in software, firmware or hardware, and when embodied in software, can be downloaded to reside on and be operated from different platforms used by real time network operating systems.

Also described herein are exemplary apparatuses for performing the operations herein. These apparatuses may be specially constructed for the required purposes, or may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and displays presented herein are not inherently related to any particular computer or other apparatus, Various general-purpose systems may also be used with programs in accordance with the teachings herein, or it may prove convenient to construct more specialized apparatus to perform the required method steps. The required structure for a variety of these systems will appear from the description above. In addition, the inventions described herein are not described with reference to any particular programming language. It is appreciated that a variety of programming languages may be used to implement the teachings of the present invention as described herein, and any references to specific languages are provided for disclosure of enablement and best mode of the present invention.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the inventions.

We claim:

1. A computer-implemented method for providing a hosted communication event between a host and at least one user, the method comprising:
receiving, through a first interface, information relating to at least one host, the information stored in at least one host profile, each host profile comprising information specifying at least one communication event with the host, information about when the communication event will take place, and information specifying one or more actions that a user must perform to take place in the communication event;
receiving, from at least one user through a second interface, a request for the at least one communication event with the host;
facilitating, automatically by a computer, the one or more actions that the user must perform to take place in the communication event as specified in the host profile corresponding to the requested communication event;
selecting at least one user that has performed the one or more actions; and
providing, by the computer over a network, the requested communication event to at least one selected user.

2. The method of claim 1, wherein receiving, from the at least one user, a request for the at least one communication event with the host, further comprises:
determining if the host specified in the request corresponds to a stored host profile;
if no stored host profile is found, soliciting participation from the specified host.

3. The method of claim 1, wherein the step of facilitating, automatically by a computer, the one or more actions that the user must perform to take place in the communication event as specified in the host profile corresponding to the requested communication event, further comprises:
using a lottery algorithm to determine one or more winners from the at least one users, wherein the probability of winning is calculated based on one or more pre-determined rules.

4. The method of claim 1, wherein the step of facilitating, automatically by a computer, the one or more actions that the user must perform to take place in the communication event as specified in the host profile corresponding to the requested communication event, further comprises:
enabling the user to make a payment to at least one entity, wherein the at least one entity is specified by the host.

5. The method of claim 4, wherein the at least one entity is a charity.

6. The method of claim 1, wherein the step of facilitating, automatically by a computer, the one or more actions that the user must perform to take place in the communication event as specified in the host profile corresponding to the requested communication event, further comprises:
conducting an auction, wherein the user provides at least one bid, and the step of selecting the at least one user comprises selecting the at least one user from a plurality of users that have submitted bids.

7. The method of claim 1, wherein the at least one communication event is an interactive video-chat session.

8. A system for providing a hosted communication event between a host and at least one user, the system comprising:
a first interface for receiving information relating to at least one host;
a memory for storing the information relating to the at least one host in at least one host profile, each host profile comprising information specifying at least one communication event with the host, information about when the communication event will take place, and information specifying one or more actions that a user must perform to take place in the communication event;
a second interface for receiving, from at least one user, a request for the at least one communication event with the host;
a processor for
facilitating the one or more actions that the user must perform to take place in the communication event as specified in the host profile corresponding to the requested communication event, and
selecting at least one user that has performed the one or more actions; and
a module for providing, by the computer over a network, the requested communication event to the at least one selected user.
